(19) United States
(12) Patent Application Publication
(10) Pub. No.: US 2006/0201920 A1
(43) Pub. Date: Sep. 14, 2006

(54) Laser beam processing machine

(75) Inventors: Hiroshi Morikazu, Tokyo (JP); Keiji Nomaru, Tokyo (JP); Katsuharu Negishi, Tokyo (JP)

Correspondence Address: SMITH, GAMBRELL & RUSSELL, 1850 M STREET, N.W., SUITE 800, WASHINGTON, DC, 20036, US

(73) Assignee: Disco Corporation

(21) Appl. No.: 11/369,945

(22) Filed: Mar. 8, 2006

(30) Foreign Application Priority Data
Mar. 9, 2005 (JP) 2005-064867

(51) Int. Cl. B23K 26/08

(52) U.S. Cl. 219/121.82; 219/121.83; 219/121.81

(57) ABSTRACT

A laser beam processing machine comprising a chuck table for holding a workpiece, a laser beam application means for applying a laser beam to the workpiece held on the chuck table, a processing-feed means for moving the chuck table and the laser beam application means relative to each other in a processing-feed direction (X), and an indexing-feed means for moving the chuck table and the laser beam application means relative to each other in an indexing-feed direction (Y) perpendicular to the processing-feed direction (X), wherein the machine further comprises a processing-feed amount detection means for detecting a processing-feed amount; an indexing-feed amount detection means for detecting an indexing-feed amount; and a control means, which has a storage means for storing the X and Y coordinate values of a minute hole to be formed in the workpiece, and controls the laser beam application means based on the X and Y coordinate values of the minute hole stored in the storage means and detection signals from the processing-feed amount detection means and the indexing-feed amount detection means.

### FIELD OF THE INVENTION

The present invention relates to a laser beam processing machine for forming a plurality of minute holes in a workpiece.

### DESCRIPTION OF THE PRIOR ART

In the manufacturing process of a semiconductor device, a plurality of areas are sectioned by dividing lines called “streets” arranged in a lattice pattern and a device such as IC or LSI is formed in each of these sectioned areas on the front surface of a substantially disk-like semiconducgor wafer. Individual semiconductor chips are manfuacturred by cutting this semiconductor wafer along the dividing lines to be divided into the areas each having a device formed thereon.

To reduce the size and increase the number of functions of an apparatus, a modular structure for connecting the electrodes of a plurality of semiconductor chips which are stacked up in layers has been implemented. This modular structure is a structure in which a through-hole (via-hole) is formed in portions where electrodes are formed in the semiconductor wafer, and a conductive material such as aluminum for connecting the electrodes is buried in the via-holes, as disclosed in JP-A 2003-163323.

The above via-holes (through-hole) formed in the semiconductor wafer are generally formed by a drill. However, the diameters of the via-holes (through-hole) formed in the semiconductor wafer are as small as 100 to 300 μm, and perforation by the drill to form the via-holes is not always satisfactory in terms of productivity.

### SUMMARY OF THE INVENTION

It is an object of the present invention to provide a laser beam processing machine capable of forming minute holes in a workpiece such as a semiconductor wafer efficiently.

To attain the above object, according to the present invention, there is provided a laser beam processing machine comprising a chuck table for holding a workpiece, a laser beam application means for applying a laser beam to the workpiece held on the chuck table, a processing-feed means for moving the chuck table and the laser beam application means relative to each other in a processing-feed direction (X), and an indexing-feed means for moving the chuck table and the laser beam application means relative to each other in an indexing-feed direction (Y) perpendicular to the processing-feed direction (X), wherein

the machine further comprises:

a processing-feed amount detection means for detecting a relative processing-feed amount between the chuck table and the laser beam application means;

an indexing-feed amount detection means for detecting a relative indexing-feed amount between the chuck table and the laser beam application means; and

a control means, which has a storage means for storing the X and Y coordinate values of a minute hole to be formed in the workpiece, and controls the laser beam application means based on the X and Y coordinate values of the minute hole stored in the storage means and detection signals from the processing-feed amount detection means and the indexing-feed amount detection means; and

the control means outputs an irradiation signal to the laser beam application means when the X and Y coordinate values of the minute hole stored in the storage means based on signals from the feed amount detection means and the indexing-feed amount detection means reach the application position of the laser beam application means.

According to the present invention, since the X and Y coordinate values of a minute hole to be formed in the workpiece are stored and a laser beam is applied to the X and Y coordinate values to form a minute hole, the minute hole can be formed in the workpiece efficiently as compared with a drill which has been conventionally used.

### BRIEF DESCRIPTION OF THE DRAWINGS

FIG. 1 is a perspective view of a laser beam processing machine constituted according to the present invention;

FIG. 2 is a plan view of a semiconductor wafer as a workpiece;

FIG. 3 is a partially enlarged plan view of the semiconductor wafer shown in FIG. 2;

FIG. 4 is a perspective view showing a state where the semiconductor wafer shown in FIG. 2 is put on the surface of a protective tape mounted on an annular frame;

FIG. 5 is a diagram showing the relationship between the semiconductor wafer shown in FIG. 2 and its coordinates when it is held at a predetermined position of the chuck table of the laser beam processing machine shown in FIG. 1;

FIGS. 6(a) and 6(b) are explanatory diagrams showing the perforation step which is carried out by the laser beam processing machine shown in FIG. 1; and

FIGS. 7(a) and 7(b) are explanatory diagrams showing the perforation step which is carried out by the laser beam processing machine shown in FIG. 1.

### DETAILED DESCRIPTION OF THE PREFERRED EMBODIMENTS

The laser beam processing machine constituted according to the present invention will be described in more detail herein under with reference to the accompanying drawings.

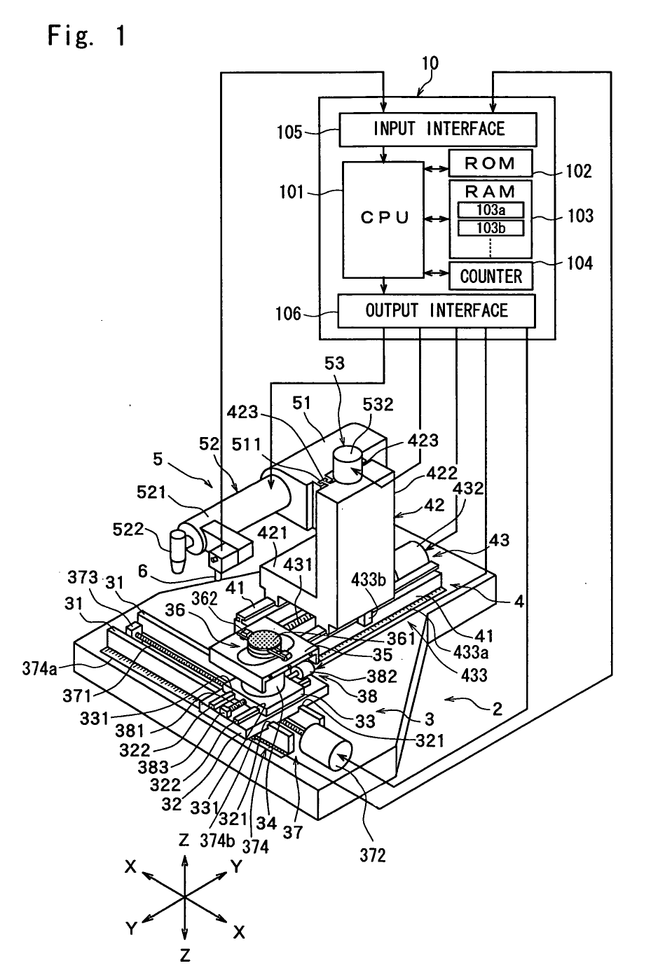

FIG. 1 is a perspective view of a laser beam processing machine constituted according to the present invention. The laser beam processing machine shown in FIG. 1 comprises a stationary base 2, a chuck table mechanism 3 for holding a workpiece, which is mounted on the stationary base 2 in such a manner that it can move in a processing-feed direction indicated by an arrow X, a laser beam application unit support mechanism 4, which is mounted on the stationary base 2 in such a manner that it can move in an indexing-feed direction indicated by an arrow Y perpendicular to the direction indicated by the arrow X, and a laser beam application unit 5, which is mounted on the laser beam application unit support mechanism 4 in such a manner that it can move in a direction indicated by an arrow Z.

The above chuck table mechanism 3 comprises a pair of guide rails 31 and 31, which are mounted on the stationary base 2 and arranged parallel to each other in the processing-feed direction indicated by the arrow X, a first sliding block 32 that is mounted on the guide rails 31 and 31 in such a manner that it can move in the processing-feed direction indicated by the arrow X, a second sliding block 33 that is mounted on the first sliding block 32 in such a manner that it can move in the indexing-feed direction shown by the arrow Y, a support table 35 supported on the second sliding block 33 by a cylindrical member 34, and a chuck table 36 as workpiece holding means. This chuck table 36 comprises an adsorption chuck 361 made of a porous material, and a workpiece, for example, a disk-like semiconductor wafer is held on the adsorption chuck 361 by a suction means that is not shown. The chuck table 36 constituted as described above is rotated by a pulse motor (not shown) installed in the cylindrical member 34. The chuck table 36 is provided with clamps 362 for fixing an annular frame, which will be described later.

The above first sliding block 32 has, on its undersurface, a pair of to-be-guided grooves 321 and 321 to be fitted to the above pair of guide rails 31 and 31 and, on its top surface, a pair of guide rails 322 and 322 formed parallel to each other in the indexing-feed direction shown by the arrow Y. The first sliding block 32 constituted as described above can move along the pair of guide rails 31 and 31 in the processing-feed direction indicated by the arrow X by fitting the to-be-guided grooves 321 and 321 to the pair of guide rails 31 and 31, respectively. The chuck table mechanism 3 in the illustrated embodiment comprises a processing-feed means 37 for moving the first sliding block 32 along the pair of guide rails 31 and 31 in the processing-feed direction indicated by the arrow X. The processing-feed means 37 has a male screw rod 371 arranged between the above pair of guide rails 31 and 31 parallel thereto, and a drive source such as a pulse motor 372 for rotary-driving the male screw rod 371. The male screw rod 371 is, at its one end, rotatably supported to a bearing block 373 fixed on the above stationary base 2 and is, at its other end, transmission-coupled to the output shaft of the above pulse motor 372. The male screw rod 371 is screwed into a threaded through-hole formed in a female screw block (not shown) projecting from the undersurface of the center portion of the first sliding block 32. Therefore, by driving the male screw rod 371 in a normal direction or reverse direction with the pulse motor 372, the first sliding block 32 is moved along the guide rails 31 and 31 in the processing-feed direction indicated by the arrow X.

The laser beam processing machine in the illustrated embodiment comprises a processing-feed amount detection means 374 for detecting the processing-feed amount of the above chuck table 36. The processing-feed amount detection means 374 comprises a linear scale 374a arranged along the guide rail 31 and a read head 374b which is mounted on the first sliding block 32 and moves along the linear scale 374a together with the first sliding block 32. The read head 374b of this processing-feed amount detection means 374 supplies one pulse signal for every 1 μm to a control means that will be described later in the illustrated embodiment. The control means later described counts the input pulse signals to detect the processing-feed amount of the chuck table 36. When the pulse motor 372 is used as a drive source for the above processing-feed means 37, the processing-feed amount of the chuck table 36 can be detected by counting the drive pulses of the control means later described for outputting a drive signal to the pulse motor 372. When a servo motor is used as a drive source for the above processing-feed means 37, a pulse signal from a rotary encoder for detecting the revolution of the servo motor is supplied to the control means which in turn counts the input pulse signals to detect the processing-feed amount of the chuck table 36.

The above second sliding block 33 has, on the undersurface, a pair of to-be-guided grooves 331 and 331 to be mated with the pair of guide rails 322 and 322 formed on the top surface of the above first sliding block 32 and can move in the indexing-feed direction shown by the arrow Y by fitting the to-be-guided grooves 331 and 331 to the pair of guide rails 322 and 322, respectively. The chuck table mechanism 3 in the illustrated embodiment has a first indexing-feed means 38 for moving the second sliding block 33 in the indexing-feed direction shown by the arrow Y along the pair of guide rails 322 and 322 formed on the first sliding block 32. The first indexing-feed means 38 comprises a male screw rod 381, which is arranged between the above pair of guide rails 322 and 322 parallel thereto, and a drive source such as a pulse motor 382 for rotary-driving the male screw rod 381. The male screw rod 381 is, at its one end, rotatably supported to a bearing block 383 fixed on the top surface of the above first sliding block 32 and is, at the other end, transmission-coupled to the output shaft of the above pulse motor 382. The male screw rod 381 is screwed into a threaded through-hole formed in a female screw block (not shown) projecting from the undersurface of the center portion of the second sliding block 33. Therefore, by driving the male screw rod 381 in a normal direction or reverse direction with the pulse motor 382, the second sliding block 33 is moved along the guide rails 322 and 322 in the indexing-feed direction shown by the arrow Y.

The above laser beam application unit support mechanism 4 comprises a pair of guide rails 41 and 41, which are mounted on the stationary base 2 and arranged parallel to each other in the indexing-feed direction shown by the arrow Y, and a movable support base 42 mounted on the guide rails 41 and 41 in such a manner that it can move in the direction shown by the arrow Y. This movable support base 42 is composed of a movable support portion 421 movably mounted on the guide rails 41 and 41 and a mounting portion 422 mounted on the movable support portion 421. The mounting portion 422 is provided with a pair of guide rails 423 and 423 extending parallel to each other in the direction shown by the arrow Z on one of its flanks. The laser beam application unit support mechanism 4 in the illustrated embodiment comprises a second indexing-feed means 43 for moving the movable support base 42 along the pair of guide rails 41 and 41 in the indexing-feed direction shown by the arrow Y. This second indexing-feed means 43 comprises a male screw rod 431 arranged between the above pair of guide rails 41 and 41 parallel thereto, and a drive source such as a pulse motor 432 for rotary-driving the male screw rod 431. The male screw rod 431 is, at its one end, rotatably supported to a bearing block (not shown) fixed on the above stationary base 2 and is, at the other end, transmission-coupled to the output shaft of the above pulse motor 432. The male screw rod 431 is screwed into a threaded through-hole formed in a female screw block (not shown) projecting from the undersurface of the center portion of the movable support portion 421 constituting the movable support base 42. Therefore, by driving the male screw rod 431 in a normal direction or reverse direction with the pulse motor 432, the movable support base 42 is moved along the guide rails 41 and 41 in the indexing-feed direction shown by the arrow Y.

The laser beam processing machine in the illustrated embodiment comprises an indexing-feed amount detection means 433 for detecting the indexing-feed amount of the movable support base 42 of the above laser beam application unit support mechanism 4. This indexing-feed amount detection means 433 is composed of a linear scale 433a arranged along the guide rail 41 and a read head 433b which is mounted on the movable support base 42 and moves along the linear scale 433a. The read head 433b of the indexing-feed amount detection means 433 supplies one pulse signal for every 1 μm to the control means later described in the illustrated embodiment. The control means counts the input pulse signals to detect the indexing-feed amount of the laser beam application unit 5. When the pulse motor 432 is used as a drive source for the above second indexing-feed means 43, the indexing-feed amount of the laser beam application unit 5 can be detected by counting the drive pulses of the control means later described for outputting a drive signal to the pulse motor 432. When a servo motor is used as a drive source for the above second indexing-feed means 43, a pulse signal from a rotary encoder for detecting the revolution of the servo motor is supplied to the control means later described which in turn counts the input pulse signals to detect the indexing-feed amount of the laser beam application unit 5.

The laser beam application unit 5 in the illustrated embodiment comprises a unit holder 51 and a laser beam application means 52 secured to the unit holder 51. The unit holder 51 has a pair of to-be-guided grooves 511 and 511 to be slidably fitted to the pair of guide rails 423 and 423 formed on the above mounting portion 422 and is supported in such a manner that it can move in the direction shown by the arrow Z by fitting the to-be-guided grooves 511 and 511 to the above guide rails 423 and 423, respectively.

The illustrated laser beam application means 52 applies a pulse laser beam from a condenser 522 mounted on the end of a cylindrical casing 521 arranged substantially horizontally. An image pick-up means 6 for detecting the area to be processed by the above laser beam application means 52 is mounted on the front end of the casing 521 constituting the above laser beam application means 52. This image pick-up means 6 comprises an illuminating means for illuminating the workpiece, an optical system for capturing the area illuminated by the illuminating means, and an image pick-up device (CCD) for picking up an image captured by the optical system. An image signal is supplied to the control means that is not shown.

The laser beam application unit 5 in the illustrated embodiment has a moving means 53 for moving the unit holder 51 along the pair of guide rails 423 and 423 in the direction shown by the arrow Z. The moving means 53 comprises a male screw rod (not shown) arranged between the pair of guide rails 423 and 423 and a drive source such as a pulse motor 532 for rotary-driving the male screw rod. By driving the male screw rod (not shown) in a normal direction or reverse direction with the pulse motor 532, the unit holder 51 and the laser beam application means 52 are moved along the guide rails 423 and 423 in the direction shown by the arrow Z. In the illustrated embodiment, the laser beam application means 52 is moved up by driving the pulse motor 532 in a normal direction and moved down by driving the pulse motor 532 in the reverse direction.

The laser beam processing machine in the illustrated embodiment comprises the control means 10. The control means 10 is constituted by a computer which comprises a central processing unit (CPU) 101 for carrying out arithmetic processing based on a control program, a read-only memory (ROM) 102 for storing the control program, etc., a read/write random access memory (RAM) 103 for storing data on the design values of the workpiece and the results of operations both of which will be described later, a counter 104, an input interface 105 and an output interface 106. Detection signals from the above processing-feed amount detection means 374, the image pick-up means 6, etc. are inputted to the input interface 105 of the control means 10. Control signals are output from the output interface 106 of the control means 10 to the pulse motor 372, the pulse motor 382, the pulse motor 432, the pulse motor 532 and the laser beam application means 52. The above random access memory (RAM) 103 has a first storage area 103a for storing data on the design values of the workpiece later described, a second storage area 103b for storing data on the detection values later described, and other storage area.

The laser beam processing machine in the illustrated embodiment is constituted as described above, and its operation will be described hereinbelow.

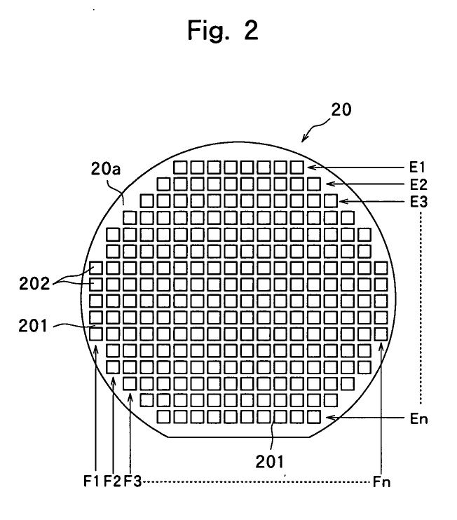

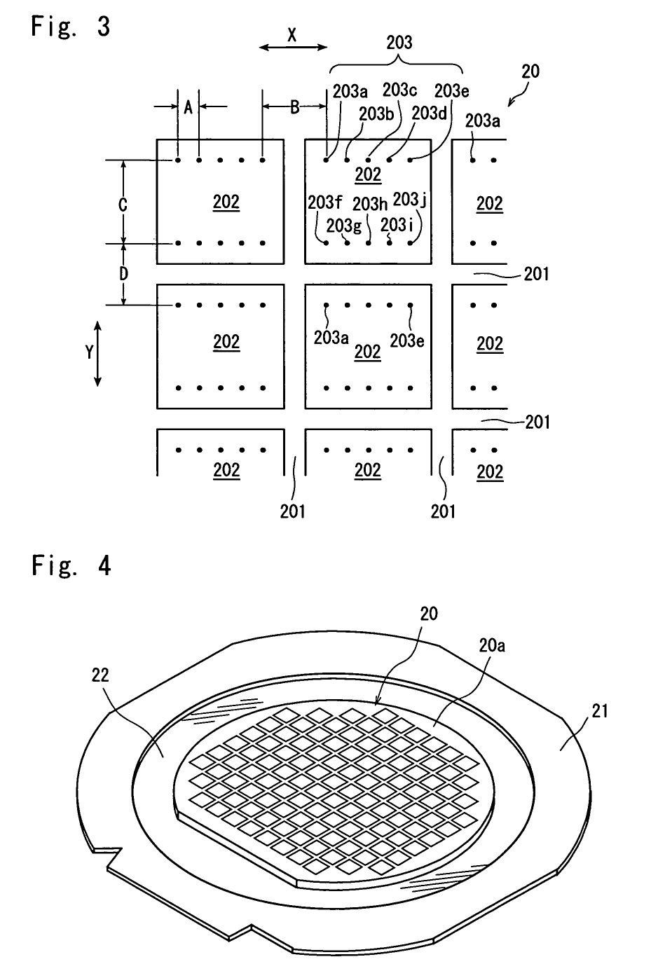

FIG. 2 is a plan view of a semiconductor wafer 20 as the workpiece to be processed by a laser beam. The semiconductor wafer 20 shown in FIG. 2 is a silicon wafer, a plurality of areas are sectioned by a plurality of dividing lines 201 formed in a lattice pattern on the front surface 20a, and a device 202 such as IC or LSI is formed in each of the sectioned areas. Each of the devices 202 is the same in constitution. A plurality of electrodes 203 (203a to 203j) are formed on the surface of each device 202, as shown in FIG. 3. In the illustrated embodiment, electrodes 203a and 203f, electrodes 203b and 203g, electrodes 203c and 203h, electrodes 203d and 203i, and electrodes 203e and 203j are at the same positions in the X direction. A through-hole (via-hole) is formed in each of the plurality of electrodes 203 (203a to 203j). The intervals A in the X direction (horizontal direction in FIG. 3) between electrodes 203 (203a to 203j) on each of the devices 202 and the intervals B in the X direction (horizontal direction in FIG. 3) between adjacent electrodes, with the dividing line 201 being interposed therebetween, that is, between the electrodes 203e and 203a out of the electrodes 203 formed on each of the devices 202 are set to be at the same interval in the illustrated embodiment. Further, the intervals C in the Y direction (vertical direction in FIG. 3) between electrodes 203 (203a to 203j) on each of the devices 202 and the intervals D in the Y direction (vertical direction in FIG. 3) between adjacent electrodes, with the dividing line 201 being interposed therebetween, that is, between the electrodes 203f and 203a and between the electrodes 203j and 203e out of the electrodes formed on each of the devices 202 are set to be at the same interval in the illustrated embodiment. In the semiconductor wafer 20 constituted as described above, the design value data on the numbers of devices 202 disposed in rows E1 to En and columns F1 to Fn shown in FIG. 2 and the above intervals A, B, C and D are stored in the first storage area 103a of the above random access memory (RAM) 103.

An embodiment of laser processing for forming a via-hole in the electrodes 203 (203a to 203j) of each device 202 formed on the above semiconductor wafer 20 by using the above laser beam processing machine will be described hereinunder.

The semiconductor wafer 20 constituted as described above is put on a protective tape 22, which is formed of a synthetic resin sheet such as polyolefin and the like and mounted on an annular frame 21, in such a manner that the front surface 20a faces up, as shown in FIG. 4.

The semiconductor wafer 20 thus supported to the annular frame 21 via the protective tape 22 is placed on the chuck table 36 of the laser beam processing machine shown in FIG. 1 in such a manner that the protective tape 22 comes into contact with the chuck table 36. The semiconductor wafer 20 is suction-held on the chuck table 36 via the protective tape 22 by activating the suction means that is not shown. Further, the annular frame 21 is fixed by clamps 362.

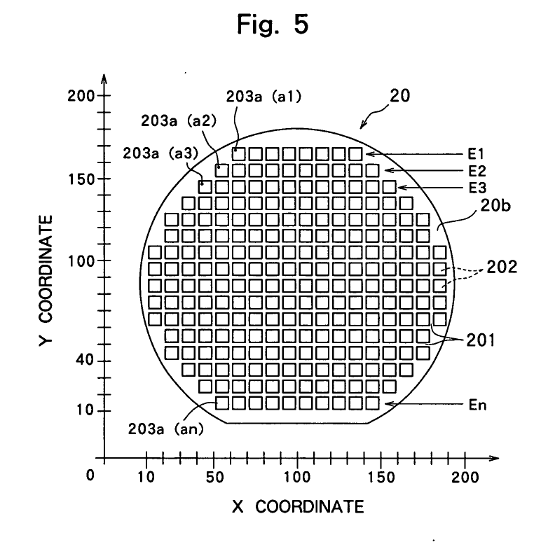

The chuck table 36 suction-holding the semiconductor wafer 20 as described above is brought to a position right below the image pick-up means 6 by the processing-feed means 37. After the chuck table 36 is positioned right below the image pick-up means 6, the semiconductor wafer 20 on the chuck table 36 becomes a state where it is located at a coordinate position shown in FIG. 5. In this state, alignment work is carried out to check whether the dividing lines 201 formed in a lattice pattern on the semiconductor wafer 20 held on the chuck table 36 are parallel to the X direction and the Y direction or not. That is, an image of the semiconductor wafer 20 held on the chuck table 36 is picked up by the image pick-up means 6 to carry out image processing such as pattern matching etc. for the alignment work.

Thereafter, the chuck table 36 is moved to bring a device at the most left end in FIG. 5 in the top row E1 out of the devices 202 formed on the semiconductor wafer 20 to a position right below the image pick-up means 6. Further, the upper left electrode 203a in FIG. 5 out of the electrodes 203 (203a to 203j) formed on the device 202 is brought to a position right below the image pick-up means 6. After the image pick-up means 6 detects the electrode 203a in this state, its coordinate values (a1) are supplied to the control means 10 as first processing-feed start position coordinate values. The control means 10 stores the coordinate values (a1) in the random access memory (RAM) 103 as first processing-feed start position coordinate values (processing-feed start position detecting step). Since the image pick-up means 6 and the condenser 522 of the laser beam application means 52 are arranged at the predetermined interval in the X direction at this point, a value obtained by adding the interval between the above image pick-up means 6 and the condenser 522 to the processing-feed amount detected by the processing-feed amount detection means 374 is stored as an X coordinate value.

After the first processing-feed start position coordinate values (a1) of the device 202 in the top row E1 in FIG. 5 are detected as described above, the chuck table 36 is moved by a distance corresponding to the interval between the dividing lines 201 in the indexing-feed direction shown by the arrow Y and moved in the processing-feed direction indicated by the arrow X to bring a device 202 at the most left end in the second row E2 from the top in FIG. 5 to a position right below the image pick-up means 6. Further, the upper left electrode 203a in FIG. 5 out of the electrodes 203 (203a to 203j) formed on the device 202 is brought to a position right below the image pick-up means 6. After the image pick-up means 6 detects the electrode 203a in this state, its coordinate values (a2) are supplied to the control means 10 as second processing-feed start position coordinate values. The control means 10 stores the coordinate values (a2) in the second storage area 103b of the random access memory (RAM) 103 as second processing-feed start position coordinate values. Since the image pick-up means 6 and the condenser 522 of the laser beam application means 52 are arranged at the predetermined interval in the X direction at this point as described above, a value obtained by adding the interval between the above image pick-up means 6 and the condenser 522 to the processing-feed amount detected by the processing-feed amount detection means 374 is stored as an X coordinate value. The above indexing-feed and the processing-feed start position detecting steps are repeated up to the bottom row En in FIG. 5 to detect the processing-feed start position coordinate values (a3 to an) of the devices 202 formed in each of the rows, and store them in the second storage area 103b of the random access memory (RAM) 103.

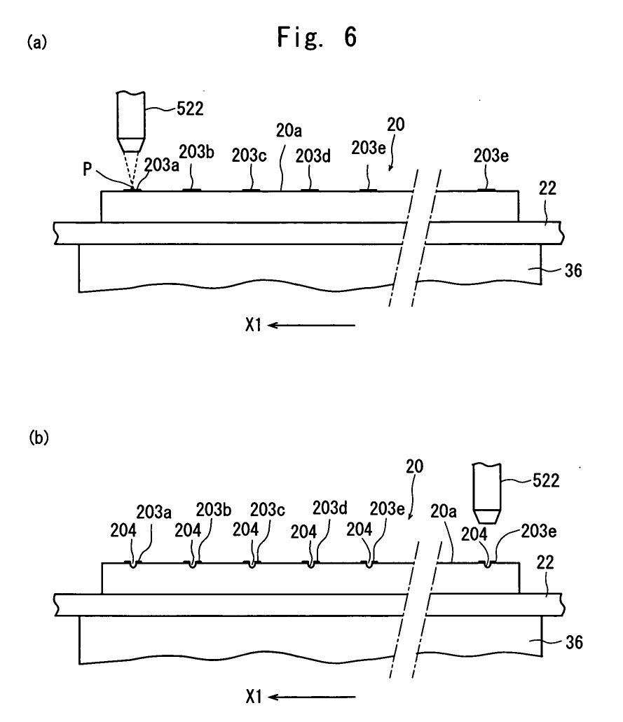

Next comes the step of perforating a through-hole (via-hole) in the electrodes 203 (203a to 203j) formed on each device 202 of the semiconductor wafer 20. In the perforation step, the processing-feed means 37 is first activated to move the chuck table 36 to bring the first processing-feed start position coordinate values (a1) stored in the second storage area 103b of the above random access memory (RAM) 103 to a position right below the condenser 522 of the laser beam application means 52. FIG. 6(a) shows a state where the first processing-feed start position coordinate values (a1) is positioned right below the condenser 522. In the state shown in FIG. 6(a), the control means 10 activates the laser beam application means 52 to apply one pulse laser beam from the condenser 522 and controls the above processing-feed means 37 to move (processing-feed) the chuck table 36 in the direction indicated by the arrow X1 at a predetermined moving rate. Therefore, one pulse laser beam is applied to the electrode 203a at the first processing-feed start position coordinate values (a1). At this point, the focusing point P of the laser beam applied from the condenser 522 is set to a position near the front surface 20a of the semiconductor wafer 20. Meanwhile, the control means 10 receives a detection signal from the read head 374b of the processing-feed amount detection means 374 and counts the detection signals by means of the counter 104. Then, when the count value of the counter 104 reaches a value corresponding to the interval A in the X direction in FIG. 3 between the electrodes 203, the control means 10 activates the laser beam application means 52 to apply one pulse laser beam from the condenser 522. Consecutively, the control means 10 activates the laser beam application means 52 to apply one pulse laser beam from the condenser 522 every time when the count value of the counter 104 reaches a value corresponding to the interval A or B between the electrodes 203 in the X direction in FIG. 3. Then, as shown in FIG. 6(b), when the electrode 203e at the most right end in FIG. 3 out of the electrodes 203 formed on the device 202 at the most right end in the row E1 of the semiconductor wafer 20 reaches the condenser 522 as shown in FIG. 6(b), the control means 10 controls to activate the laser beam application means 52 to apply one pulse laser beam from the condenser 522 and then, to suspend the movement of the above processing-feed means 37 to stop the movement of the chuck table 36. As a result, laser-processed holes 204 are formed in the electrodes 203 (not shown) of the semiconductor wafer 20, as shown in FIG. 6(b).

The processing conditions of the above perforation step are set as follows, for example.
Light source: LD excited Q switch Nd: YVO4
Wavelength: 355 nm
Output: 3 W
Focusing spot diameter: 50 μm
Processing-feed rate: 100 mm/sec

When the perforation step is carried out under the above conditions, laser-processed holes 204 having a depth of about 5 μm can be formed in the semiconductor wafer 20.

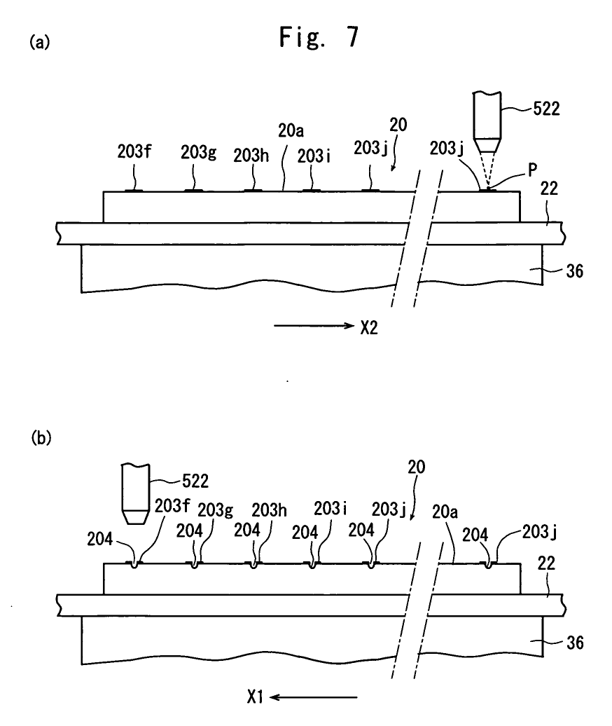

Thereafter, the control means 10 controls the above second indexing-feed means 43 to move (indexing-feed) the condenser 522 of the laser beam application means 52 in the indexing direction perpendicular to the sheet in FIG. 6(b). Meanwhile, the control means 10 receives a detection signal from the read head 433b of the indexing-feed amount detection means 433, and counts the detection signal by means of the counter 104. Then, when the count value of the counter 104 reaches a value corresponding to the interval C in the Y direction in FIG. 3 between the electrodes 203, the activation of the second indexing-feed means 43 is suspended to stop the indexing-feed of the condenser 522 of the laser beam application means 52. As a result, the condenser 522 is positioned right above the electrode 203j opposed to the above electrode 203e (see FIG. 3). This state is shown in FIG. 7(a). In the state shown in FIG. 7(a), the control means 10 activates the laser beam application means 52 so as to apply one pulse laser beam from the condenser 522, and controls the above processing-feed means 37 to move (processing-feed) the chuck table 36 in the direction indicated by the arrow X2 in FIG. 7(a) at a predetermined moving rate. Then, the control means 10 counts detection signals from the read head 374b of the processing-feed amount detection means 374 by means of the counter 104 as described above, and activates the laser beam application means 52 to apply one pulse laser beam from the condenser 522 each time when the count value reaches the interval A or B between the electrodes 203 in the X direction in FIG. 3. Then, as shown in FIG. 7(b), when the electrode 203f formed on the device 202 at the most right end in the row E1 of the semiconductor wafer 20 reaches the condenser 522, the control means 10 controls to activate the laser beam application means 52 to apply one pulse laser beam from the condenser 522 and then, to suspend the movement of the above processing-feed means 37 to stop the movement of the chuck table 36. As a result, laser-processed holes 204 are formed in the electrodes 203 (not shown) of the semiconductor wafer 20 as shown in FIG. 7(b).

After the laser-processed holes 204 are formed in the electrodes 203 formed on the devices 202 in the row E1 of the semiconductor wafer 20, the control means 10 activates the processing-feed means 37 and the second indexing-feed means 43 to bring the second processing-feed start position coordinate values (a2) stored in the second storage area 103b of the above random access memory (RAM) 103 in the electrode 203 formed on the device 202 in the row E2 of the semiconductor wafer 20 to a position right below the condenser 522 of the laser beam application means 52. Then, the control means 10 controls the laser beam application means 52, the processing-feed means 37 and the second indexing-feed means 43 to carry out the above-mentioned perforation step on the electrodes 203 formed on the devices 202 in the row E2 of the semiconductor wafer 20. Hereafter, the above perforation step is also carried out on the electrodes 203 formed on the devices 202 in the rows E3 to En of the semiconductor wafer 20. As a result, laser-processed holes 204 are formed in all the electrodes 203 formed on the devices 202 of the semiconductor wafer 20.

When the above perforation step is carried out under the above processing conditions, the laser-processed holes 204 having a depth of about 5 μm can be formed in the semiconductor wafer 20. Accordingly, when the thickness of the semiconductor wafer 20 is 50 μm, the above perforation step is repeated 10 times to form a through-hole (via-hole) consisting of the laser-processed holes 204. To this end, the thickness of the semiconductor wafer 20 as a workpiece and the number of pulses required for forming a through-hole (via-hole) based on the depth of a laser-processed hole which can be formed in the workpiece by one pulse laser beam are stored in the above random access memory (RAM) 103 in advance. Then, the above perforation steps are counted and repeated until the number of pulses required for forming the through-hole (via-hole) reaches the above count value. Thus, by using the laser beam processing machine of the present invention, minute holes can be formed in the workpiece such as a semiconductor wafer efficiently as compared with a drill that has been conventionally used.

What is claimed is:

1. A laser beam processing machine comprising a chuck table for holding a workpiece, a laser beam application means for applying a laser beam to the workpiece held on the chuck table, a processing-feed means for moving the chuck table and the laser beam application means relative to each other in a processing-feed direction (X), and an indexing-feed means for moving the chuck table and the laser beam application means relative to each other in an indexing-feed direction (Y) perpendicular to the processing-feed direction (X), wherein
the machine further comprises:
a processing-feed amount detection means for detecting a relative processing-feed amount between the chuck table and the laser beam application means;
an indexing-feed amount detection means for detecting a relative indexing-feed amount between the chuck table and the laser beam application means; and
a control means, which has a storage means for storing the X and Y coordinate values of a minute hole to be formed in the workpiece, and controls the laser beam application means based on the X and Y coordinate values of the minute hole stored in the storage means and detection signals from the processing-feed amount detection means and the indexing-feed amount detection means; and
the control means outputs an irradiation signal to the laser beam application means when the X and Y coordinate values of the minute hole stored in the storage means based on signals from the processing-feed amount detection means and the indexing-feed amount detection means reaches the application position of the laser beam application means.
